(19) United States
(12) Patent Application Publication
(10) Pub. No.: US 2016/0125815 A1
(43) Pub. Date: May 5, 2016

(54) SYSTEM AND METHOD FOR CONTROLLING DISPLAY BRIGHTNESS

(71) Applicant: SYMBOL TECHNOLOGIES, INC., Lincolnshire, IL (US)

(72) Inventors: Eliav Bar Shimon, Oryehuda (IL); Shimon Barness, Matan (IL); Kevin Cordes, Miller Place, NY (US); Yair Lior, Hertzliya (IL); Dror Moshe, Ganei Tikva (IL)

(21) Appl. No.: 14/532,139

(22) Filed: Nov. 4, 2014

(51) Int. Cl. G09G 3/34; G06K 7/14; G09G 5/10

(52) U.S. Cl. CPC G09G 3/3406; G09G 5/10; G06K 7/1413; G09G 2320/0626; G09G 2330/021

(57) ABSTRACT

A method and apparatus for regulating display brightness at a data capture device comprising a display is provided. Initially, the brightness of the display can be regulated to a first level. When an initiation of a data capture operation is detected, the brightness of the display can be regulated to a predetermined level. When a termination of the data capture operation is detected, the brightness of the display can be regulated back to the first level. An application specific integrated circuit (ASIC) having a normal operational state and a dimming operational state, can also be provided. The ASIC can operate to change operational states based on a detection of at least one of an activation of the trigger mechanism, a deactivation of the trigger mechanism, an activation of the capture ongoing output apparatus, a deactivation of the capture ongoing output apparatus and a deactivation of the compete output apparatus.

### BACKGROUND OF THE INVENTION

Data capture devices such as bar code scanners facilitate information retrieval from objects and locations in a convenient manner. For example, a bar code scanner may be used to read bar codes on prepackaged items at a point of sale. Accordingly, an operator may identify a product being purchased and its associated price by scanning a bar code and eliminating the need to type the information manually, speeding up the checkout process significantly.

Data capture devices typically include a display to assist with the scanning operations. For example, the display may provide information regarding scan parameters, allowing a scanned code to be reviewed. The display can also allow display of information related to the general operations of the data capture device.

Displays can be a significant drain for power, in particular because the lighting elements used for displays typically require significant power. This is undesirable, especially in cases where the device is battery operated. For example, a depleted battery requires an operator to stop the operations and either swap batteries, find an alternative power source or swap the data capture device with another one, all of which are disruptive to the information retrieval process. Accordingly, systems and methods are needed to better manage the power requirements of a display so as to reduce the power requirements of a data capture device

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a data capture device in accordance with some embodiments.

FIG. 2 is a flowchart of a method for controlling display brightness of the data capture device of FIG. 1 in accordance with some embodiments.

FIG. 3 is a block diagram of an apparatus for backlight control for use with the data capture device of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An apparatus and method for regulating display brightness at a data capture device is provided. In operation, the brightness of the display can be regulated to a first level. When an initiation of a data capture operation is detected, the brightness of the display can be regulated to a predetermined level. When a termination of the data capture operation is detected, the brightness of the display can be regulated back to the first level. An application specific integrated circuit (ASIC) having a normal operational state and a dimming operational state, can also be provided. The ASIC can operate to change operational states based on a detection of at least one of an activation of the trigger mechanism, a deactivation of the trigger mechanism, an activation of the capture ongoing output apparatus, a deactivation of the capture ongoing output apparatus and a deactivation of the compete output apparatus.

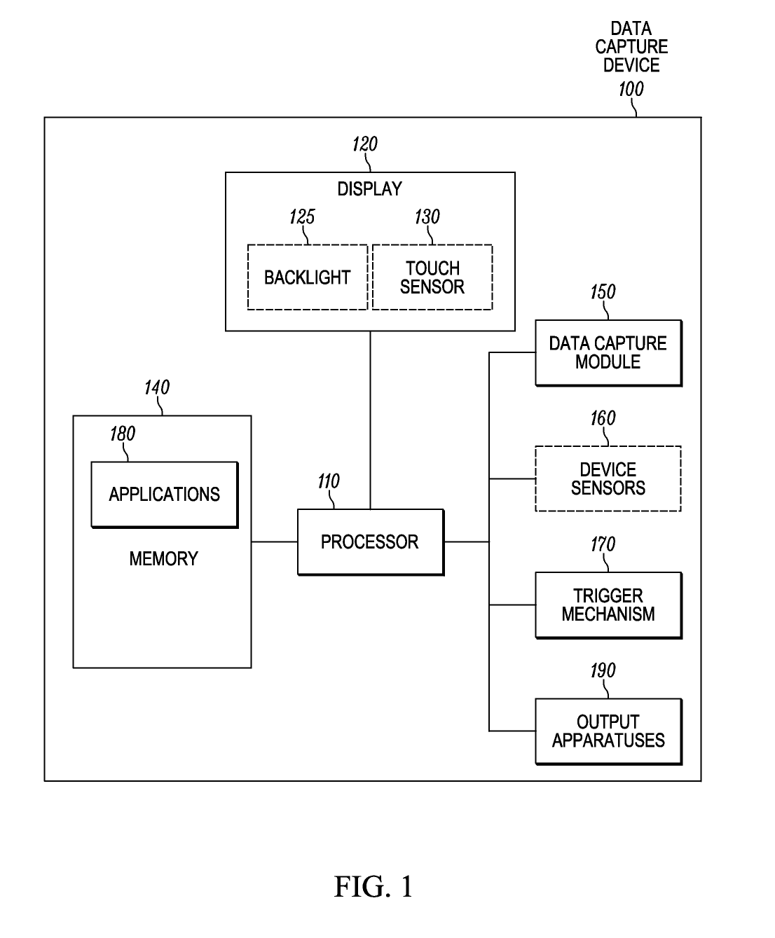

FIG. 1 is a block diagram of a data capture device 100 in which methods and components required for performing a variable data capture process is implemented in accordance with the embodiments. The data capture device 100 may take form of, but is not limited to, handheld devices such as a smart phone, a bar code scanner, optical code reader and the like, a data capture terminal connected to a handheld device, desktop, laptop or notebook computer, an automated teller machine, a kiosk, a vending machine, a payment machine, facsimile machine, a point of sale device and the like.

The connection from a data capture terminal can be wired or wireless. In accordance with some embodiments, it will be appreciated that the connection can utilize a wireless communication system, a wired communication system, a broadcast communication system, or any other equivalent communication system. For example, the communication system may function utilizing any wireless radio frequency channel, for example, a one or two-way messaging channel, a mobile cellular telephone channel, or a mobile radio channel. Similarly, it will be appreciated that the communication system may function utilizing other types of communication channels such as Institute of Electrical and Electronics Engineers (IEEE) 802.11, IEEE 802.16 and/or Bluetooth channels. Further, it will be appreciated that the communication system may function utilizing a wireline communication channel such as a local area network (LAN) or a wide area network (WAN) or a combination of both. The LAN, for example, may employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among the devices and/or chargers. The WAN, for example, may use a physical network media such as X.25, Frame Relay, ISDN, Modem dial-up or other media to connect devices or other local area networks. In the following description, the term “communication system” or “connection” refers to any of the systems mentioned above or an equivalent. Embodiments may be advantageously implemented to perform variable data capture processes on the data capture device 100. Embodiments may be implemented in any electronic device performing data capture.

The data capture device 100 comprises a processor 110, a display 120 comprising an optional backlight 125 and an optional touch sensor 130, memory 140, a data capture module 150, one or more optional device sensors 160, a trigger mechanism 170, and one or more output apparatuses 190. The data capture device 100 also includes a power source (not shown) providing appropriate power to all the components of the device 100. The power source can be battery based or alternating current obtained from an external source such as a wall outlet.

The processor 110 runs or executes operating instructions or the applications 180 that are stored in the memory 140 to perform various functions for the data capture device 100 and to process data. The processor 110 includes one or more microprocessors, microcontrollers, digital signal processors (DSP), state machines, logic circuitry, or any device or devices that process information based on operational or programming instructions stored in the memory 140. In accordance with the embodiments, the processor 110 processes various functions and data associated with carrying out the variable data capture process.

The display 120 provides a user interface between the data capture device 100 and a user. The display 120 can be realized as an electronic display configured to graphically display information and/or content under the control of the processor 110. Depending on the implementation of the embodiment, the display 120 may be realized as a liquid crystal display (LCD), a touch-sensitive display, a cathode ray tube (CRT), a light emitting diode (LED) display, an organic light emitting diode (OLED) display, a plasma display, a projection display, or another suitable electronic display comprising a brightness control mechanism. For, example, in some embodiments that include a backlight 125, as shown in FIG. 1, the display brightness can be controlled by controlling the brightness or the light output of the backlight 125.

In some embodiments, as shown in FIG. 1, the display 120 can optionally include a touch sensor 130 to form a touch screen. The touch sensor can provide a user interface, for example an input interface that can complement an output interface provided by the display 120. The touch sensor 130 can have a touch-sensitive surface, sensor, or a set of sensors that accepts input from the user based on haptic and/or tactile contact. The touch sensor 130 can be operated on by an input apparatus (such as a finger of a user or other input device such as a stylus, including passive and active) to provide touch sensitive inputs to the data capture device 100.

Although the block diagram of FIG. 1 shows touch sensor 130 to be an integral part of the display 120, in some embodiments, the data capture device 100 can include a touch sensor 130 that is separate from the display 120. In further embodiments, there may be more than one touch sensor 130, at least some of which being separate from the display 120. In general, the term “touch sensor” will be used throughout the description to represent any touch sensitive surface or panel. In some embodiments, the touch sensor 130 may be used in conjunction with the display 120, to receive input during the data capture process on the data capture device 100.

The data capture module 150 includes one or more data sensors for capturing data from various data sources. A data sensor may be an optical sensor such as a charge-coupled device (CCD) sensor, a laser scanner and the like, that may capture data from optical data sources such as bar codes, quick response (QR) codes and video response (VR) codes and other similar optical data sources. Data sensors may also include electromagnetic sensors such as near field communication (NFC) sensors and radio frequency identification (RFID) readers that may capture data from electromagnetic data sources such as from RFID tags and NFC tags, acoustic sensors such as ultrasonic devices, or voice sensors and the like. The data capture module 150 may also include additional components to aid with its operation such as lasers for scanning optical data, optics for directing light to image sensors and antennae for aiding data reception by electromagnetic readers. To capture optical data, the optics of the data capture module 150 may be pointed at the data source, such as a bar code, at an appropriate distance. To capture RFID or NFC data, antennae associated with the RFID reader or NFC sensor are brought within a prescribed range of the item containing the RFID or NFC tag. In accordance with some embodiments, the data capture device 100 can include multiple data capture modules 150, each module including one or more data sensors.

In variations the data capture module 150 can be in the form of a data capture terminal, separate from and connected to the data capture device 100. The data capture terminal containing the data capture module 150 can take on various forms including the form of a handheld device such as a handheld scanner, a wearable device such as a ring scanner worn on a finger, a mounted terminal such as a scanning terminal and the like. The connection between the data capture terminal and the data capture device 100 can be wired or wireless as discussed above.

The optional device sensors 160 detect various physical forces applied to the data capture device 100. For example, device sensors 160 such as motion sensors including accelerometers and gyroscopes, can detect acceleration and changes in orientation respectively. Other device sensors 160 such as pressure sensors can detect pressure applied to the housing or display 120 of the data capture device 100. A force sensor can be fabricated using any suitable force sensing technology. Device sensors 160 can include further sensors such as magnetometers, and the like.

The trigger mechanism 170 can be a virtual mechanism and/or a physical mechanism, the activation of which enables the performance of a data capture operation by data capture device 100. For example, the activation of the trigger mechanism 170 can initiate a data capture operation by the data capture module 150. A physical trigger mechanism can include a physical switch, a capacitive or optical sensor, a pressure sensor, a microphone or other physical mechanisms which can be activated through the provision of a physical input such as pressure and/or touch applied to the mechanism. A virtual trigger mechanism can be implemented through software applications. For example, the display 120 in combination with touch sensor 130 can provide virtual trigger mechanisms such as one or more virtual keys or buttons on the display 120 which may be activated by providing an input to the touch sensor 130. In other variations, the trigger mechanism 170 can be activated through provision of specific audio inputs such as voice commands and the like. In yet further variations, the trigger mechanism can be activated through one or more gestures received by the touch sensor 130, or the optional device sensors 160.

At some point after the initiation of the data capture module 150, the data capture operation is terminated. In some embodiments, the termination of the data capture operation can be based on a deactivation of the trigger mechanism 170. In some embodiments, the trigger mechanism 170 can be deactivated when an input, the reception of which caused the activation of the trigger mechanism 170, is no longer received. For example, when the trigger mechanism 170 is implemented as a physical switch and the input received corresponds to the depression of that switch, the deactivation of the trigger mechanism 170 can occur when the switch is released. As a further example, in a touch based implementation, when the activation input received is a particular touch, the deactivation can occur when that particular touch can no longer be detected. In some embodiments, the trigger mechanism 170 can be deactivated when an input subsequent to the activation input is received. For example, a trigger switch can be pressed a second time following its initial depression to activate the trigger mechanism. Alternatively, a touch button can be touched a second time, following the initial selection of the touch button.

In some embodiments, the termination of the data capture operation can occur automatically, when, for example, data is captured successfully, such as when a bar code is successfully read. In other embodiments the termination of data capture can occur automatically when data capture fails, such as when a bar code cannot be successfully read. In some embodiments a capture complete signal can be generated when the data capture operation is terminated.

One or more output apparatuses 190 can provide further information regarding the operational status of the device. The output apparatuses 190 can be any apparatuses capable of providing feedback to an operator. Accordingly, the output apparatuses 190 may be in the form of an audio output apparatus, such as a speaker, a haptic device such as a vibrator, or a visual apparatus such as a display or a light emitting diode (LED), or a combination of such apparatuses. For example, a capture ongoing indicator can be provided through one or more of the output apparatuses 190, such as an LED, to indicate that a data capture operation has been activated and is ongoing. Alternatively, or in addition, in some embodiments, a user of the data capture device 100 can be made aware that the data capture operation is complete through the provision of a capture complete indicator through one or more of the output apparatuses 190, such as an LED. The capture complete indicator can be generated on the basis of a capture complete signal. Moreover, the output apparatus 190 providing the capture ongoing indicator can be turned off in response to the termination of the data capture operation.

The memory 140 can be an IC (integrated circuit) memory chip containing any form of RAM (random-access memory) or ROM (read-only memory), a CD-RW (compact disk with read write), a hard disk drive, a DVD-RW (digital versatile disc with read write), a flash memory card, external subscriber identity module (SIM) card or any other non-transitory medium for storing digital information. The memory 140 comprises applications 180. The applications 180 include various software and/or firmware programs and instructions necessary for the operation of the data capture device 100 as well as software and/or firmware programs and instructions (e.g. warehouse applications, email applications etc.) that address specific requirements of the operator.

To save power and thus, for example, to elongate the operational time of a battery operated data capture device, the brightness of the display 120 can be dimmed to a predetermined level so as to reduce the power requirements of the display 120. Alternatively, the display 120 brightness may be reduced by a predetermined percentage from its current level. For example, where the display 120 includes a backlight, as shown in FIG. 1, the backlight 125 can be dimmed. Alternatively, in variations where the display 120 does not have a backlight, such as when the display 120 is an OLED based display, other mechanisms may be employed, such as dimming the brightness of individual pixels, or displaying certain types of images which can reduce power consumption. In another variation, the display 120 can be turned off, instead of being dimmed.

One period during the operation of the data capture device when the display 120 can be dimmed or turned off is through a data capture operation. During the typical operation of a data capture device 100, when an operator initiates a data capture operation, the information presented on the display 120 typically ceases to be relevant. For example, during data capture operation, the operator focuses his or her attention to appropriately positioning the data capture device 100, accordingly diverting attention away from the display 120. Dimming or turning off the display 120 during a data capture operation can thus present an opportunity to save power. Moreover, reducing power requirements of the display 120 during the operation of the data capture module 150, which is activated when a data capture operation is initiated, has the added advantage of lowering the peak power requirement of the data capture device 100 during data capture operations.

To dim or turn off the display 120 during a data capture operation, the initiation of a data capture operation can be detected. In one variation, the detection can be based on the activation of the trigger mechanism 170. Additionally or in the alternative, the detection can be based on an activation of the one or more output apparatuses 190 which provide the capture ongoing indicator.

Once the initiation of data capture is detected, the display 120 brightness can be reduced to a preset level or turned off. The brightness reduction can be effected by various mechanisms such as lowering the brightness of the backlight 125, turning off the backlight 125, sending a special image to the display, turning off the display itself and others that will be appreciated by persons of skill.

Following the alteration of the display's brightness level (or turning it off), the termination of the data capture operation is detected. The detection can be based on various mechanisms. For example a deactivation of the trigger mechanism 170 or a deactivation of the output apparatuses 190 providing the capture ongoing indicator can be used as the basis of the detection. Alternatively, an activation of the output apparatus 190 providing the capture complete indicator output can be used. As a further example, the detection of a capture complete signal can be used as a basis of detecting the termination of a data capture operation.

When the termination of the data capture operation is detected, the display 120's brightness level may be returned to its previous levels (levels prior to the activation of the data capture operation, for example). This may be accomplished by returning the backlight to a previous brightness, turning the display 120 back on or by ceasing the display of the specialized image, for example.

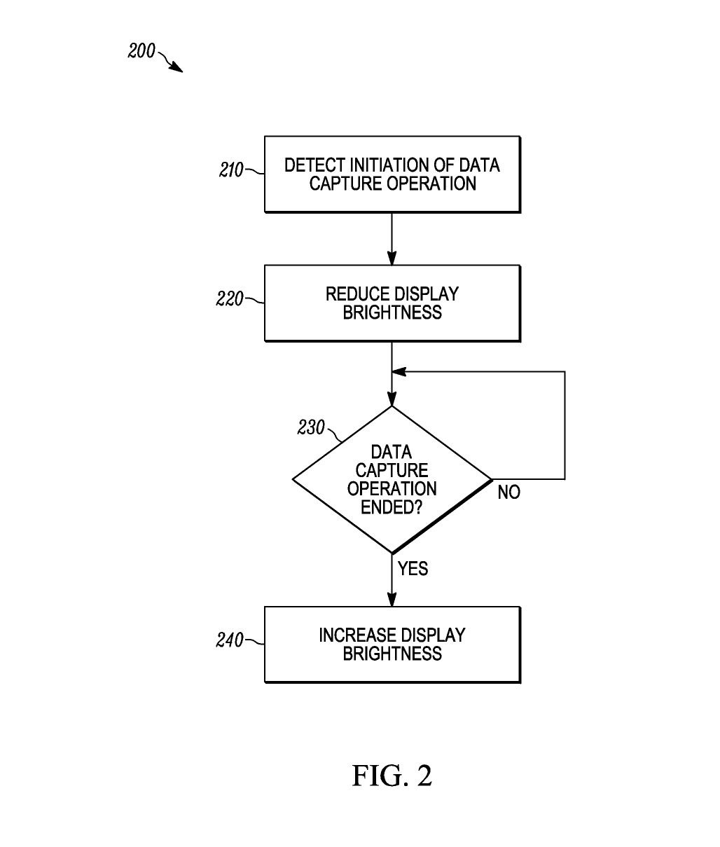

FIG. 2 represents a flowchart of a method 200 for controlling the display 120 brightness at the data capture device 100 of FIG. 1 in accordance with some embodiments. As shown in FIG. 2, the method 200 begins by detecting that a data capture operation has been initiated. In this illustrative example of FIG. 1, the detection is based on an activation of the trigger mechanism 170. Moreover, in this illustrative example, the trigger mechanism 170 is an electromechanical switch activated by being depressed.

Continuing with method 200, at 220, the brightness of the display 120 is reduced. In this illustrative example of FIG. 1, the display 120 is an LCD display with an LED backlight 125. To reduce the brightness of the display 120 the backlight 125 is turned off. At 230, the data capture device 100 monitors to detect the termination of the data capture operation. In this illustrative example, the detection is made based on an activation of capture complete output apparatus 190, which is an LED. As long as the data capture operation is not terminated, the monitoring continues. Once a detection is made that the data capture operation is terminated (in this illustrative example, the capture complete LED turns on), the display 120's brightness is restored at 240, by turning on the backlight 125.

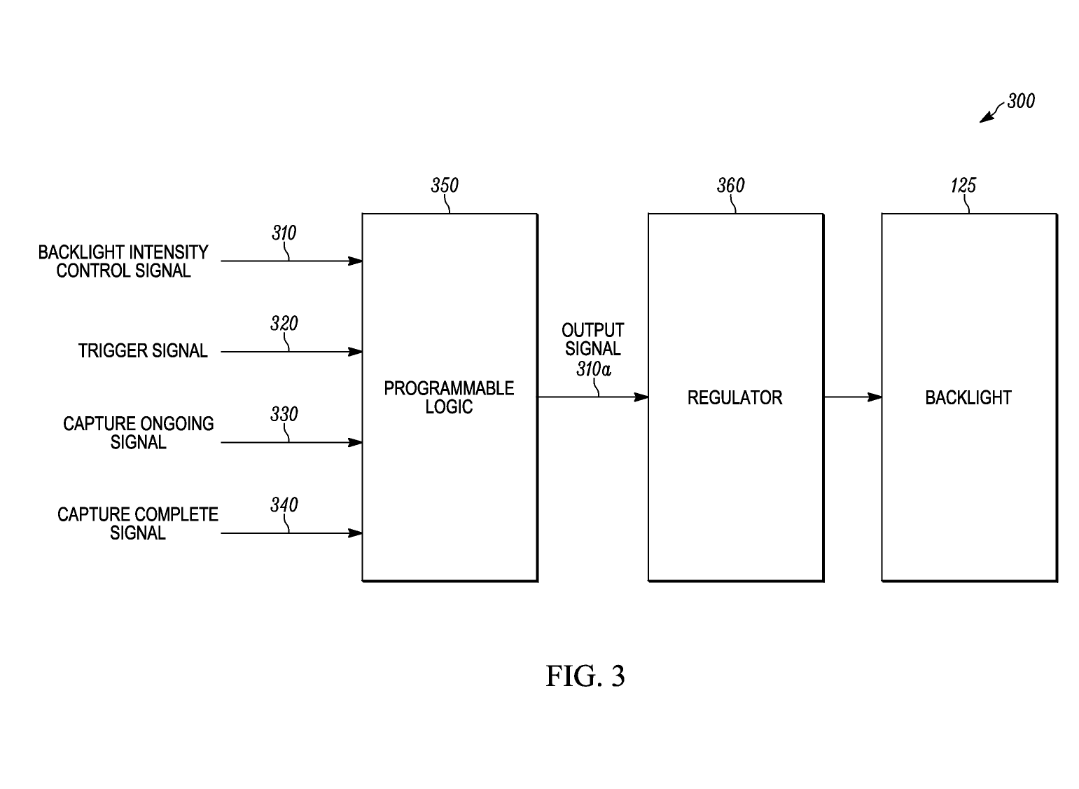

To improve user experience, the delay between the detection of the initiation and termination of a data capture operation and the corresponding change in the display 120 brightness can be reduced by providing control circuitry in the form of hardware or firmware to effect the control of the display 120 brightness. Referring to FIG. 3 a block diagram of an apparatus for controlling the display 120 brightness is shown at 300. The apparatus is for use in the data capture device 100 to control the backlight 125.

The brightness control apparatus 300 includes an application specific integrated circuit (ASIC) 350 and a regulator 360. The ASIC 350 can be implemented as any application specific integrated circuit such as a programmable logic device, a programmable logic array, a field-programmable gate array and the like. The ASIC 350 receives, as input, a backlight intensity control signal 310. The backlight intensity control signal is the system level signal that represents the system set brightness of the display 120.

The ASIC 350 can generate an output signal 310a which can be a modified form of the brightness control signal 310. The regulator 360 receives the output signal 310a and regulates the backlight intensity of the backlight 125 based on the output signal 310a. For example, the output signal 310a can regulate the backlight 125 brightness through pulse width modulation. Accordingly, as a simplified illustrative example, when the duty cycle of the output signal 310a is at approximately 100%, the regulator 360 can set the brightness of the backlight at approximately 100%. Alternatively, when the duty cycle of the output signal 310a is approximately 30%, the backlight brightness can be set at approximately 30%. As yet another example, when the duty cycle of the output signal 310a is at approximately 0%, the backlight can be turned off.

In normal operational state of the ASIC 350, the display brightness may be maintained at the system specified level as indicated by the backlight intensity control signal 310. For example, the ASIC 350 can pass through the brightness control signal 310 without any modification (or generate a close match), such that the output signal 310a is a close approximation of the brightness control signal 310. In such circumstances, the brightness of the backlight 125 remains unaltered in comparison with when the system set brightness level.

In variations, the ASIC 350 can enter a dimming operational state. In the dimming state, the ASIC 350 can modify the backlight intensity control signal such that the output signal 310a causes a change in the backlight 125 brightness in comparison to the system set brightness level. For example, the duty cycle of the output signal 310a can be lowered in comparison to the duty cycle of the backlight intensity control signal 310.

The ASIC 350 can enter a dimming state when a start of a data capture operation is detected and exit the dimming state when a termination of the data capture operation is detected. In some embodiments, the ASIC 350 can receive additional input signals which can be used to determine the initiation and termination of a data capture operation. The additional input signals can include inputs from the trigger mechanism 170, and the output apparatuses 190 which provide the indicators for capture ongoing and capture complete. Accordingly, as shown in FIG. 3, the ASIC 350 can receive a trigger signal 320 which indicates when the trigger mechanism 170 has been activated (for example the trigger signal 320 can indicate logic high), when for example, a trigger switch is pressed, and when the trigger mechanism 170 has been deactivated (for example, the trigger signal 320 can indicate logic low), when for example, the trigger switch is released. Moreover, the ASIC 350 can receive a capture ongoing signal 330 indicating when the capture ongoing output apparatus 190 is turned on (logic high) or off (logic low), as well as a capture complete signal 340 indicating when the capture complete output apparatus 190 has been turned on (logic high) or off (logic low).

Accordingly, in some variations, the ASIC 350 can operate in the normal operational state where the output signal 310a closely matches the brightness control signal 310. During the normal operational state, when the ASIC 350 detects that that the trigger signal 320 indicates an activation of the trigger mechanism 170 and/or the capture complete signal indicates an activation of the capture complete output apparatus 190, the ASIC 350 can enter the dimming state, causing the output signal 310a to be modified to cause the brightness of the backlight 125 to be reduced in comparison to the normal state. In some variations, a backlight brightness change occurs when the system set display brightness, as indicated by the backlight intensity control signal 310, is above a predetermined threshold. Under such circumstances, the output signal 310a can be modified to cause the backlight 125 brightness to be set to a predetermined value, lower than that indicated by the backlight intensity control signal 310. When the system set display brightness is at or below a threshold, on the other hand, the output signal 310a can continue to closely match the backlight intensity control signal 310, thus not modifying the backlight 125 brightness from the system set level.

The ASIC 350, when in the dimming state can revert back to the normal state when the data capture operation is complete. Accordingly, when the ASIC 350 can detect that that the trigger signal 320 indicates the deactivation of the trigger mechanism 170 and/or that the capture complete signal indicates that the capture complete output apparatus 190 has been turned off and/or that the capture complete signal indicates that the capture complete output apparatus 190 has been turned on, the ASIC 350 can enter the normal state, causing the output signal 310a to match the backlight intensity control signal 310.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of regulating display brightness at a data capture device comprising a display, the method comprising:
detecting an initiation of a data capture operation;
regulating the brightness of the display to a predetermined level in response to the detection of the data capture operation initiation, wherein the regulating the brightness of the display to the predetermined level causes the display to turn off;
detecting a termination of the data capture operation; and
regulating the brightness of the display to a first level in response to the detection of the data capture operation termination.

2. The method of claim 1, wherein the regulating the brightness of the display to the predetermined level is performed when the first level is greater than the predetermined level.

3. The method of claim 1 wherein the device further comprises a capture ongoing output apparatus and a trigger mechanism and wherein the detecting the initiation of the data capture operation is based on a detection of at least one of an activation of the trigger mechanism and an activation of the capture ongoing output apparatus.

4. The method of claim 1 wherein the device further comprises a capture ongoing output apparatus, a capture complete output apparatus and a trigger mechanism and wherein detecting the termination of the data capture operation is based on a detection of at least one of a deactivation of the trigger mechanism, a deactivation of the capture ongoing output apparatus and an activation of the capture complete output apparatus.

5. The method of claim 1 wherein the data capture device further comprises a application specific integrated circuit (ASIC) and the regulating and the detecting are performed by the ASIC.

6. The method of claim 1 wherein the regulating the brightness of the display to the predetermined level further comprises:
displaying a predetermined image.

7. (canceled)

8. The method of claim 1 wherein the display comprises a backlight and regulating the brightness of the display to the predetermined level further comprises regulating the brightness of the backlight to the predetermined level.

9. A data capture device comprising:
a display further comprising a backlight;
a trigger mechanism;
a capture ongoing output apparatus;
a capture complete output apparatus;
an application specific integrated circuit (ASIC) having a normal operational state and a dimming operational state, wherein the dimming operational state causes the display to turn off, the ASIC operating to:
change operational states based on a detection of at least one of an activation of the trigger mechanism, a deactivation of the trigger mechanism, an activation of the capture ongoing output apparatus, a deactivation of the capture ongoing output apparatus and a deactivation of the capture complete output apparatus.

10. The data capture device of claim 9 wherein the changing the operational states further comprises:
when the ASIC is in the normal operational state:
detect at least one of the activation of the trigger mechanism and the activation of the capture ongoing output apparatus; and
regulate the brightness of the backlight to a predetermined level.

11. The data capture device of claim 10 wherein ASIC further operates to:
receive a backlight intensity control signal for regulating the backlight brightness,
wherein the regulate the brightness of the backlight to a predetermined level further comprises:
modifying the backlight intensity control signal; and
outputting the modified backlight intensity control signal.

12. The data capture device of claim 11 wherein changing the operational states further comprises:
when the ASIC is in the dimming operational state:
detect at least one of the deactivation of the trigger mechanism, the deactivation of the capture ongoing output apparatus and the activation of the capture complete output apparatus; and
regulate the brightness of the display to a system set level.

13. The data capture device of claim 9 wherein the ASIC is one of a programmable logic device, a programmable logic array and a field-programmable gate array.

14. The data capture device of claim 9 wherein the capture ongoing output apparatus is a light emitting diode (LED).

15. The data capture device of claim 9 wherein the capture complete output apparatus is a light emitting diode (LED).
